(19) United States
(12) Patent Application Publication
(10) Pub. No.: US 2007/0038528 A1
(43) Pub. Date: Feb. 15, 2007

(54) Inventory-less distribution

(75) Inventors: Jackson Robie Hull, San Francisco, CA (US); Calbert Lai, Mountain View, CA (US); Frederick Charles Fiechter, Stateline, NV (US); Daniel Sheppard, Brea, CA (US); Eric Hassman, San Francisco, CA (US)

Correspondence Address: DARBY & DARBY P.C., P. O. BOX 5257, NEW YORK, NY, 10150-5257, US

(73) Assignee: Sitoa Corporation, San Mateo, CA (US)

(21) Appl. No.: 11/497,958

(22) Filed: Aug. 1, 2006

Related U.S. Application Data
(60) Provisional application No. 60/707,810, filed on Aug. 11, 2005.

(51) Int. Cl. G06Q 30/00

(52) U.S. Cl. 705/26

(57) ABSTRACT

A method in support of an e-commerce transaction between an outlet and a customer with respect to products not held in inventory by the outlet. A provider facilitates the transaction by making available for selection a set of products available for inclusion as a product offering on an outlet's web site. When a customer selects one of the items not held in inventory by the outlet, the outlet transmits a purchase order to the provider; the provider then transmits a second purchase order for the selected product to a supplier and awaits an acceptance of the purchase order from the supplier. The provider transmits the branding requirements of the outlet to the supplier, who packages and ships the selected product to the customer according to the branding requirements as though it were packaged and shipped by the outlet.

This application claims priority pursuant to 35 U.S.C. § 119 from Provisional Patent Application Ser. No. 60/707,810, entitled “Method and System For E-Commerce Between Suppliers and Merchants,” filed Aug. 11, 2005, the entire disclosure of which is hereby incorporated by reference.

### FIELD OF THE INVENTION

The present invention relates to a method of facilitating an e-commerce transaction, and more particularly, is directed to a method of facilitating e-commerce transactions among outlets and suppliers so as to enable outlets to offer products which are not in the outlet's inventory and enable suppliers to provide those products to customers of the outlets in a manner consistent with the branding requirements of the outlet.

### BACKGROUND OF THE INVENTION

The Internet and other distributed networks have provided a new and significant channel for conducting business transactions including the sale of merchandise. Typically, a customer visits a website of a particular outlet or web-retailer and browses an offering of products on the outlet's website. The customer can then select a specific item and purchase the item through a web interface. Many websites inform the customer if the item is in stock prior to completing the purchase transaction. After the item is purchased, the web-retailer transmits the order to its warehouse, where the item is picked, packed and shipped to the customer.

Variations on the traditional web-retailer/customer model have been created as the Internet has matured. Some web-retailers are merely the online presence of a traditional brick-and-mortar store. Thus, when the web-retailer receives an order, it can transmit the order to a brick-and-mortar store associated with the web-retailer because the brick-and-mortar store has the item in stock, or is geographically closest to the customer, or on some other basis. The brick-and-mortar store will either ship the ordered item to the customer, or allow the customer to collect the item at the selected or designated brick-and-mortar store.

Some websites facilitate transactions between customers and suppliers. For example, retailer, or supplier, aggregation web sites enable a customer to browse the products being offered by many different suppliers. The customer selects a specific product from a specific retailer through the aggregator website and purchases the item. The purchase typically occurs through the aggregator website. Alternatively, the aggregator can refer the customer to the retailer's website, where the transaction is completed.

Web-retailers also sell items for which they do not have inventory, but rather have arrangements with other suppliers. Thus, when a customer purchases an item which the web-retailer does not maintain in inventory, the web-retailer transmits the order to a supplier who then ships the item directly to the customer. The customer receives item as though it was purchased from the supplier and not the web-retailer from which the customer expected shipment. In this manner the web-retailer acts similarly to a retail aggregator except that the customer is not necessarily aware that the order will be fulfilled by a third party, but rather becomes aware of the third-party supplier when the package is received.

### SUMMARY OF THE INVENTION

In accordance with one aspect of the present invention, a method in support of an e-commerce transaction between an outlet and a customer is conducted through a distributed network with respect to products not held in inventory by the particular outlet. A provider supporting the transaction makes available for selection through the computer network a set of products available for inclusion as part of a product offering on the particular outlet's website. Each product is made available to the outlet at a price specified by the provider. The provider receives at a server a first purchase order from the particular outlet concerning a product that has been selected from the set of products not held in either the provider's or the outlet's inventory. The selected product is offered to customers in an inventory-less manner by the particular outlet. The purchase order can include prescribed transaction details of a particular customer's e-commerce transaction with the Web site of the particular outlet. The provider transmits a second purchase order for the selected product to a supplier and awaits an acceptance communicated from the supplier that the second purchase order has been accepted. Once the provider receives acceptance of the second purchase order, the provider accepts the first purchase order.

In accordance with further aspects of the present invention, the prescribed transaction details of the first purchase order include a shipping address of the particular customer. The transaction details are communicated to the accepting supplier. The supplier is further advised of the branding requirements of the particular outlet in connection with fulfillment of the first purchase order. The e-commerce transaction is fulfilled between the particular outlet and the particular customer by shipping the product from the accepting supplier directly to the particular customer in accordance with the branding requirements.

### BRIEF DESCRIPTION OF THE DRAWINGS

FIG. 1 illustrates an embodiment of a communication network that connects customers, outlets, providers, and suppliers;

FIG. 2 depicts a flow diagram illustrating steps of a process in accordance with an embodiment of the present invention;

FIG. 3 depicts a flow diagram illustrating a communication between the customer and the supplier going through the provider; and

FIG. 4 depicts a flow messaging diagram in accordance with an embodiment of the present invention.

### DETAILED DESCRIPTION OF CERTAIN PREFERRED EMBODIMENTS

By way of overview and introduction, the present invention provides a method in support of an e-commerce transaction involving a customer, an outlet, a provider, and a supplier. The outlet can include a web-based retailer, a web-presence of a brick-and-mortar store, an auction site, or any retailer selling goods over a distributed network. In the particular e-commerce transaction supported by this invention, the outlet does not maintain all the goods sold through its web-based store in inventory. Rather, the supplier holds particular goods in inventory.

The provider facilitates the coordination and communication between the supplier and the outlet, and further facilitates the delivery of goods from the supplier to the customer. In particular, the provider maintains a list, or database, of items that are available from suppliers, and preferably approved or pre-selected suppliers. The list of available items is provided to the outlets by the provider for a price determined by the provider. The outlet can select items from the provider's list that the outlet wants to include in its product offering on its website.

When a customer selects one of the items not held in inventory by the outlet, the outlet transmits a purchase order to the provider for the selected item. Preferably, the purchase order transmitted to the provider includes details regarding the transaction between the customer and the outlet. The provider then transmits its own (“a second”) purchase order for the selected item to a supplier and waits for an acceptance to be communicated from the supplier that the second purchase order has been accepted. Once the provider receives acceptance of the second purchase order, the provider accepts the first purchase order.

In a more particular feature of the present invention, the transaction details of the first purchase order include a shipping address of the customer. The transaction details are communicated from the provider to the supplier accepting the purchase order. Additionally, the provider further advises the supplier of the branding requirements of the outlet from which the first purchase order originated. The supplier fulfills the e-commerce transaction between outlet and the customer by shipping the product directly to the particular customer in accordance with the branding requirements of the outlet.

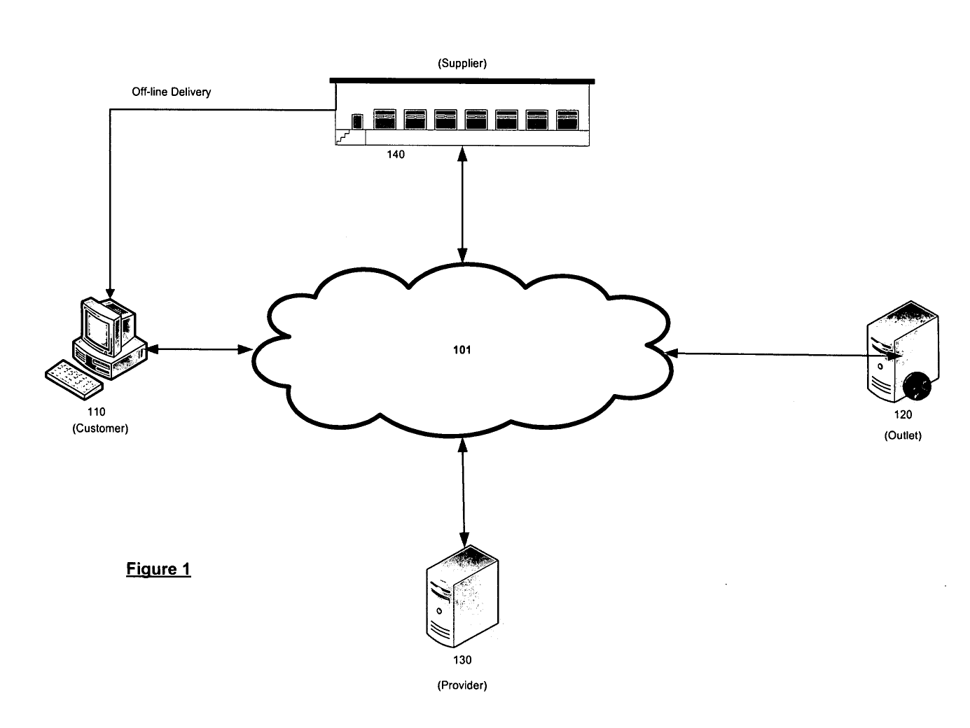

FIG. 1 illustrates an embodiment of a communication network 101 in which customers 110 at computer terminals are shown connected to an outlet 120 (e.g., web-retailer). The outlet 120 communicates with a provider 130 that facilitates the e-commerce transaction between the customer 110 and the outlet 120. The provider 130 communicates with supplier 140 to fulfill the purchase transaction for the outlet 120.

While FIG. 1 illustrates all parties to be in communication over the same distributed network 101, such as the Internet, it should be understood that the communication required by the present invention can take place over multiple and/or disjoint networks provided that the customer 110 and outlet 120 can communicate with each other, the outlet 120 and the provider 130 can communicate with each other and the provider 130 and the supplier 140 can communicate with each other. For example, the customer 110 can communicate with the outlet 120 over the Internet through the outlet's web-based store front. Alternatively, the customer 110 can communicate with the outlet 120 through a terminal located within the brick-and-mortar presence. Similarly, the outlet 120 can communicate with the provider 130, and the provider 130 with the supplier 140, over the Internet or an alternative network connection (e.g. telephone-based data link).

FIG. 1 illustrates all parties in communication via a distributed computer network 101. However, in a further detail of the present invention, not all communications of the present invention are required to be transmitted via the distributed computer network 101. For example, the provider 130 can communicate with the supplier 140 by facsimile or via telephone. Certain known advantages of speed and reliability are realized by electronic communication over a network 101. However, not all messages are required to be sent in this manner.

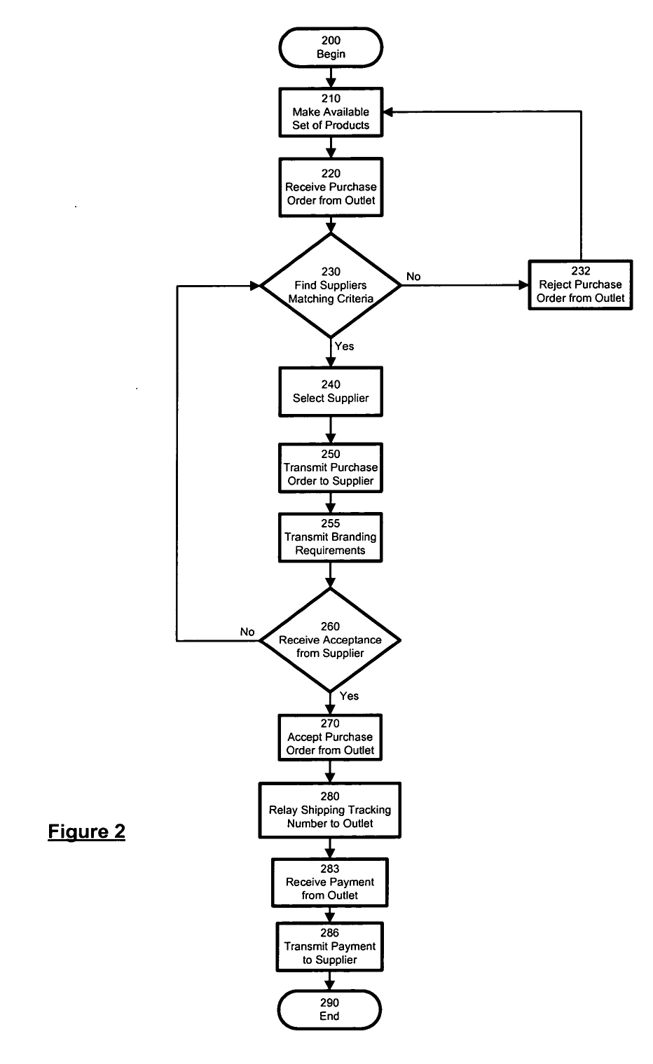

FIG. 2 depicts a flow diagram illustrating steps of a process by which the provider 130 facilitates an e-commerce transaction in accordance with an embodiment of the present invention. Beginning at step 210, the provider 130 makes available a set of products that can be selected and included by the outlet 120 as part of a product offering on the outlet's website. At step 220, the provider 130 receives a purchase order from an outlet 120. Typically the purchase order is transmitted by the outlet 120 in response to an order being placed by a customer 110 at the outlet's website in the course of an e-commerce transaction process flow which, to the customer, can be conventional while still being implemented at the backend in accordance with this invention.

The provider 130 searches its records, preferably stored in a database, for one or more suppliers 140 that match predetermined criteria. The matching process is preferably performed utilizing a rule-based engine. The rules utilized can be varied depending factors such as the outlet 120 from whom the purchase order is received, the product specified in the purchase order, and any relationships established between any of the outlet 120, the provider 130, and the supplier 140. The determination of a match can include an analysis of various factors associated with each prospective supplier 140 including inventory of the product, a price constraint, a profit margin constraint, a geographic constraint, a contractual constraint, or a combination thereof. The constraints can include optimizing certain factors such as profits, price, geographical distances, and volume of sales through either the outlet 120 or the supplier 140.

If the provider 130 can not find a supplier 140 satisfying the required criteria at step 230, then the provider 130 can reject the purchase order from the outlet 120 at step 230. In a further aspect of this invention, the provider 130 rarely proceeds to step 232 to reject the purchase order, because inventory updates from the suppliers 140 are distributed by the suppliers 140 to the provider 130, and relayed by the provider 130 to the participating outlets 120. Specifically, each supplier 140 can send updates of current inventory of specific products to the provider 130, which are then aggregated by product and selectively distributed to the outlets 120. The outlets 120 can use the inventory information to notify potential customers 110 if the item is in stock. In this manner, outlets 120 can reject orders from customers 110 at the outlet's website without necessitating communication with the provider 130 or supplier 140. Further, outlet 120 can utilize information provided by provider 130 to control its web or other commercial interface to not offer a product that is not presently in supply.

In a more detailed aspect, the provider 130 can aggregate product inventory data from suppliers 140 in accordance with rules or criteria that are specific to each outlet 120, supplier 140, or provider 130. For example, when the provider 130 is computing the inventory count to provide to a particular outlet 120, if the price of a specific product from a supplier 140 would not produce a sufficient profit for either a specific outlet 120 or the provider 130, then the inventory from that supplier 140 can be excluded from the inventory count provided to the particular outlet 120. In a further example, suppliers 140 can exclude outlets 120, and vice-versa because of a competitive relationship or prior unsatisfactory transactions. The provider 130 can further provide a numerical inventory count to the outlet 120 or simply an in-stock or out-of-stock indication.

If the provider 130 successfully determines one or more suppliers 140 matching the specified criteria, the provider 130 selects a supplier 140 at step 240. The selection can be performed randomly. Preferably, however, step 240 is performed using the same rules or additional rules utilized in step 230. For example, from the list of suppliers, a preferred supplier 140 can be selected. Alternatively, the supplier 140 can be selected to maximize profits for the provider 130 or the outlet 120.

Once the supplier 140 is selected at 240, a second purchase order is created and transmitted to the selected supplier 140. This purchase order is dependent upon the existence of the initial order by the customer, and is created in connection with the inventory-less transaction processing of the present invention. Preferably, this purchase order contains specific information regarding the transaction including the shipping address of the particular customer 110, and the item purchased. Optionally, the information provided in the purchase order to the supplier 140 can include information regarding the outlet 120 from which the e-commerce transaction was initiated. The outlet information can include a simple identification of the outlet 120 or detailed branding requirements of the outlet 120. Based on either the outlet identification and branding requirements, the supplier 140 can generate and ship the purchased item directly to the customer 110 in a manner that conforms to the branding requirements of the particular outlet 120. For example, the shipping method, shipping label, and packing slip can all reflect the name, logo, and preferences of a particular outlet 120.

The outlet information can be provided in the purchase order to the supplier 140, or as a separate communication in process 200. However, the outlet information, including the branding requirements, can be communicated outside of process 200. Preferably, the branding information provided is in the form of printable data. For example, the provider 130 can simply provide printable images to the supplier 140 who can then print and use as the shipping label, packing slip, and receipt. Alternatively, the provider 130 can transmit data concerning the transaction that is sufficient to fill in a template associated with the specific outlet 120. The templates can be transmitted to the supplier 140 in-process or out-of-process, and can be maintained in a database local to the supplier 140 for future use or reference. Additionally, the provider 130 can supply the supplier 140 with an application or plug-in program capable of receiving the transmitted transaction data that defines or describes the branded labels, receipts, packaging, or other branded forms.

After the provider 130 transmits the second purchase order to the supplier 140, the provider 130 can wait to receive acceptance of the purchase order from the supplier 140 at step 260. Awaiting acceptance can be performed by monitoring transmissions on a computer network, or other distributed network. Waiting for acceptance from the supplier 140 ensures that the supplier 140 has sufficient inventory, in case the supplier 140 has not notified the provider 130 of a recent change in inventory.

If the supplier 140 does not receive acceptance for the purchase order from the supplier 140 within a prescribed period of time, the provider 130 can return to step 230, where the rejecting supplier 140 is eliminated from the list of possible suppliers 140 for this transaction, and the provider 130 again searches for suppliers 140 matching specific criteria. Alternatively, the provider 130 can return to step 240 and select the next best supplier 140 from the list of previously identified suppliers 140. However, performing the search 230 across all suppliers 140 ensures the most recent inventory counts, prices, and other factors are accounted for in selecting a supplier 140.

If the supplier 140 accepts the purchase order from the provider 130, the provider 130 can accept the order from the outlet 120 at step 270. The provider 130 can accept the purchase order from the outlet 120 at any point after receiving it. Thus, in the absence of an acceptance from a supplier or in lieu of seeking acceptance, the provider 130 can assess the risk of non-fulfillment and proceed to step 270. However, it is preferable that the provider 130 delay accepting the purchase order from the outlet 120 until the provider 130 has determined that the supplier 140 has agreed to fulfill the order.

Once provided with the product ID, the customer shipping address, and the branding requirements of the outlet 120, the supplier 140 can ship the item directly to the customer 110. From the customer's point of view, the shipment will appear as though it came directly from the outlet 120. The packaging, shipping label, invoice, and packing slip can all appear to the customer to have been provided and generated by the outlet 120. The customer 110 can complete the transaction and receive the desired product without knowledge that the outlet 120 never held the product in stock, without knowledge that supplier 140 sourced the item, and without knowledge of the provider's role in the transaction.

Once the supplier 140 has shipped the product or generated a shipping label for the product, the shipping tracking number can be communicated to the outlet 120, directly from the supplier or indirectly by way of the provider 130, at step 280.

Payment between the parties can also be coordinated by the provider 130. Preferably, the outlet 120 transmits payment for the purchase order after the provider 130 has accepted the outlet's purchase order at step 270, and more preferably after receiving the relayed tracking number at step 280. Thus, at step 283, the provider 130 will receive payment from the outlet 120, and, now that the provider 130 has the funds from the outlet 120 and has confirmed the shipment of the product through receipt of the tracking number, the provider 130 can transmit payment to the supplier 140 at step 286. Payment between the parties can occur at varying points throughout the process 200. However, delaying payment until steps 283 and 286 prevents each party from transmitting monies not yet received from the adjacent party upstream in the transaction and delays the outlay of monies until the outlet 120 and the provider 130 are sufficiently satisfied that the transaction is complete and that the customer 110 will receive the desired product.

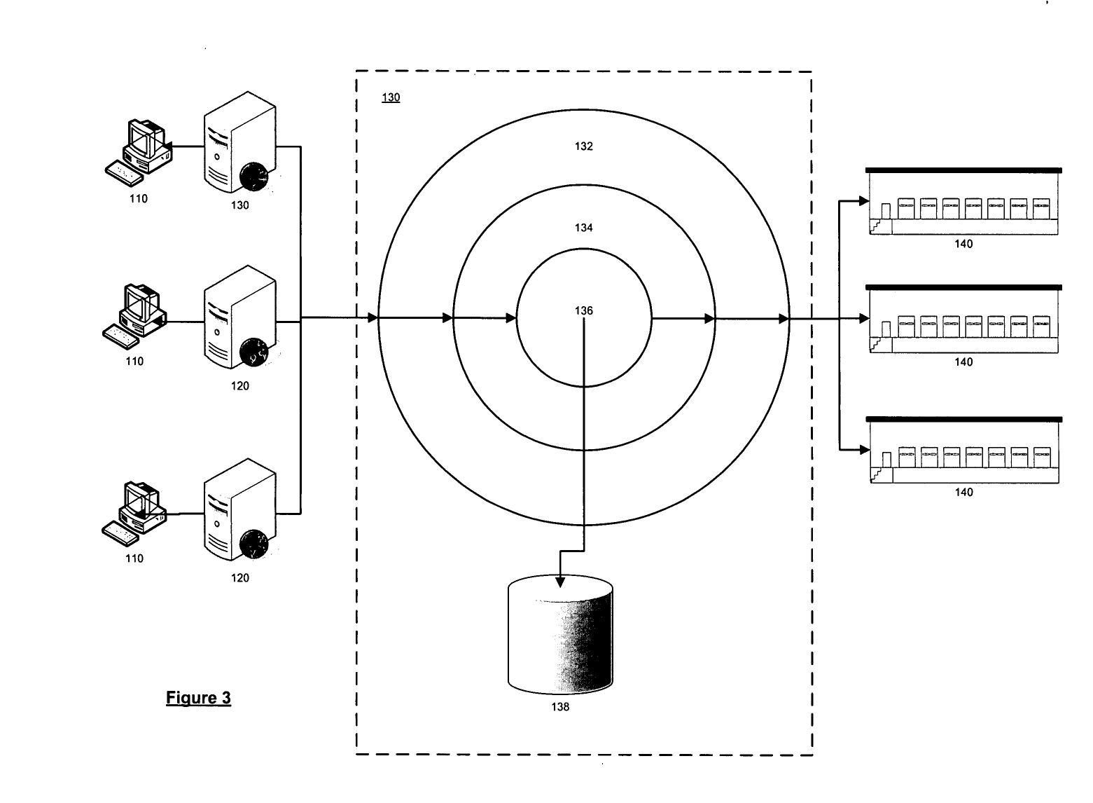

FIG. 3 depicts a flow diagram illustrating a communication from the customer 110 to the supplier 140. As previously discussed, the customer 110 places an order with the outlet 120, which typically occurs over the Internet or other distributed network. FIG. 3 illustrates three customers 110, each in communication with an outlet 120, but not necessarily the same outlet.

The outlets 120 communicate with the provider, 130 represented in FIG. 3 by the dashed line. Messages to the provider 130 are received by the communication layer 132, preferably as TCP/IP messages. The communication layer 132 can also store messages in appropriate folders which are monitored for new messages by the translation layer 134. Thus, messages can be sent via Hyper-Text Transfer Protocol (HTTP), File Transfer Protocol (FTP), or as Post or Get parameters of Common Gateway Interface (CGI) messages.

The received files and messages are passed to the translation layer 134 which parses the incoming files/messages to extract relevant information. Messages can be in any standardized or proprietary format provided that the translation layer is programmed to handle that format. For example, outlets 120 can use extensible Markup Language (XML), Electronic Data Interchange (EDI), flat files, or customized CGI messages. The translation layer 134 is further capable of translating outgoing messages into the format preferred by the receiving party (i.e., the supplier 140 or the outlet 120). In this manner, the provider 130 can communicate with many different parties in various standard or proprietary formats.

The data parsed from the messages at the translation layer 134 is passed to the application layer 136. Generally, all communication to and from the provider 130 is stored in the database 138 to create an auditable and complete record of each transaction, and the relevant data concerning the parties involved. The application layer 136 includes computer code executing in a processor and configured so as to analyze the data and perform the appropriate step outlined in process 200. The computer code can be within a program, a module, an object or other conventional software form. The translation layer 134 then receives the new outgoing data message and translates it into a format associated with the message recipient. The formatted message is then passed to the communication layer 132 which transmits it to either the supplier 140 or outlet 120.

The application layer 136 utilizes and maintains the information stored in the database 138. In one embodiment, the database 138 is a SQL database employing a database schema including tables for purchase orders, shipping notices, invoices, agreements, products, product outlets, product suppliers, and inventory. Preferably, the database is organized about three cross-referential sets of tables. Specifically, the database includes a set of product tables, a set of trading partner tables, and a set of messaging tables.

The product tables can store various information about the products supplied by the suppliers 140 and offered for sale by the outlets 120. For example, the product table can include a provider product ID that can be used to cross reference supplier-product-IDs and outlet-product-IDs. Additionally, marketing messages, labels, country of origin, manufacturer information, and other identifying information can be stored in the product tables of the database 138. This information can be provided to outlets 120 selectively as determined by further control information maintained in the database 138. Furthermore, the inventory count of each product also can be stored in the product tables.

Sales criteria, such as rules regarding required profit margins or quantity limits for specific products, can be stored in the product tables. These criteria can be associated with specific products or entire product categories. Alternatively, criteria for a particular outlet 120 or supplier 140 are preferably stored in the trading partner tables.

The trading partner tables store information about the outlets 120 and suppliers 140. For a given supplier 140, the trading partner tables can include identity information, contact information, warehouse information, geographical information, supplied products, and supplied product prices. For a given outlet 120, the trading partner tables can include identity information, contact information, branding information, and other relevant information. The trading partner tables can also specify the preferred message communication format for each supplier 140 and outlet 120. Thus, when sending a message, the provider 130 can translate the message into the appropriate format by examining the destination of the message and looking up the preferred message format in the appropriate table.

In a further detail of the trading partner tables, a set of agreement tables can store information concerning the relationships between outlets 120 and suppliers 140. This relationship information can include price commitments on specific products that have been secured from specific suppliers 140 and the products selected by a specific outlet 120 to be made available for sale. The agreement tables can further store the information required to translate a supplier-product-ID to an outlet-product-ID by creating entries in an agreement-item table that identifies the supplier-product-ID, supplier-product-ID, and provider-product ID. Additionally, the trading partner tables can further store information sufficient to enable the provider to limit a particular outlet's access to a specific supplier's products, and vice-versa, thereby preventing specific outlets 120 from viewing or including particle products from provider 130 among their offerings, and preventing specific suppliers 140 from receiving orders from a specific outlet 120.

Based on the agreements and information stored in the agreement tables, and preferably secured price commitments from suppliers 140, the provider price can be established (typically, at a price above the secured price commitment) and stored in the product tables. Additionally, after the provider price has been established, the provider price can be included in the information made available to outlets 120 regarding the products available for inclusion in their product offering.

Similarly, the database can store information regarding specific outlets 120 that permit the provider 130 to update the information displayable to a customer 110 on the outlet's website. Updates to information on the outlet's website can be pushed by the provider 130 to the outlet's web server. For example, the provider can store a password or encrypted key to negotiate access to protected webpages on the outlet's web server where information can be uploaded or modified. Alternatively, the outlet 120 can request updates from the provider 130 through an exchange of messages to synchronize the outlet's product offerings with the provider's database of available products, or the outlet 120 can request a new catalog of available products from the provider 130.

The messaging tables can coordinate and maintain a record of all communication between an outlet and the provider, and the provider and the supplier. The messaging tables can be use to create a record of all transactions and track a transaction's progress. Additionally, trading agreements and negotiations, as well as inventory updates, can also be stored in the messaging tables.

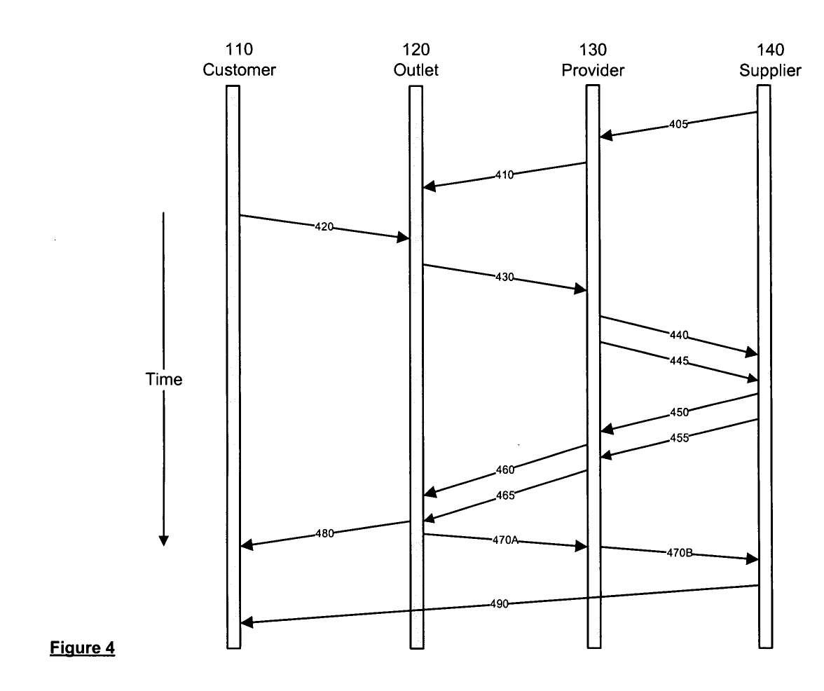

FIG. 4 depicts a flow messaging diagram of a transaction in accordance an embodiment of the present invention, and illustrates the cascade of messages between parties to complete the e-commerce transaction. The passage of time proceeds in the direction indicated by the time-arrow. Each party to the transaction is represented by a shaded vertical bar, and each arrow between the vertical bars represents a message sent by the party from which the arrow originates and received by the party indicated by the arrowhead.

Prior to a purchase by a customer 110, the supplier 140 transmits price commitments for specific products at message 405. Encapsulating the step of securing price commitments in one message 405 oversimplifies the process, because, in practice, the provider 130 and the supplier 140 negotiate a price commitment over the course of several messages and perhaps business meetings. Message 405 can also transmit the supplier's inventory of a product to the provider 130. Once the provider 130 has secured a selection of inventory from suppliers 140, and potentially secured price commitments and inventory levels, the provider 130 makes available to the outlet 120 a selection of inventory for inclusion in their product offering at 410. The product information, provider price, and inventory count can be pushed to subscribing outlets 120, or alternatively, the outlet 120 can request the information (not shown) and the provider 130 can supply the selection in response. Typically, the outlet 120 will select among various provider offerings and include a subset of them on its website.

The customer 110 upon reviewing the offerings of the outlet 120, places an order 420 for a product that is not held in inventory by the outlet 120 but is instead one of the offerings made available by the provider. The purchase order includes an identification of the product and a shipping address for the customer. The outlet 120 transmits a first purchase order 430 specifying the product, cost, shipping address, and outlet 120 identification to the provider 130.

The provider 130 receives the first purchase order 430 at communication layer 132, translates it at layer 134, and then passes the information to application layer 136, where the provider 130 preferably searches for suppliers 140 matching specific criteria at step 230. Preferably, once a list of suitable suppliers 140 has been determined, a supplier 140 is selected at step 240. A second purchase order can be generated and translated into the selected supplier's preferred message format by looking up the preferred format in the database 138 and translating the message at translation layer 134. The message conveying the second purchase order 440 is then sent through communication layer 132 to supplier 140.

Preferably, the provider 130 also transmits the originating outlet's branding requirements 445 to the supplier 140. As discussed above, the branding requirements can be communicated to the supplier 140 as part of the e-commerce transaction or prior to the transaction when the provider establishes the supplier-provider relationship or to the supplier 140 through a different route or mechanism such as from the outlet itself.

The supplier 140 accepts the purchase order and transmits the acceptance 450 to the provider 130. In response, the provider 130 transmits acceptance 460 of the first purchase order. As discussed above, the provider 130 can accept the first purchase order at any point after receiving the purchase order 430. However, it is preferred that the provider 130 delay acceptance of the first purchase order until the supplier 140 has accepted the provider's second purchase order 460. Similarly, the outlet can transmit acceptance of the customer's purchase at message 480, and this optionally can be done before receiving an acceptance of the order from the provider 130.

The shipping tracking number is transmitted at 455 by the supplier 140 to the provider 130, which is relayed to the outlet 120 by message 465, with or without additional information from the provider such as the provider's invoice. Typically, the outlet 120 does not charge the credit card of the customer 110 until the outlet 120 confirms that the package has been shipped. The party billing the customer 110 is the outlet 120, thus further insinuating to the customer 110 that the goods are from the entity that was paid (i.e., the outlet). Furthermore, the customer only makes a single payment to the outlet 120, despite the involvement of the provider 130 and supplier 140. Payments between the other involved parties are not visible, nor are they of concern, to the customer 110.

Preferably, the provider 130 transmits payment 470B to the supplier 140 after it has received notification of the shipping tracking number 455 and received payment 470A from the outlet 120. As discussed above, payment to the supplier can be transmitted earlier in the transaction communications; however, it is preferable to delay payment to the supplier 140 until the provider 130 has determined the supplier has fulfilled the second purchase order.

Up to this point in the transaction, all messages have cascaded between parties having a direct relationship with one another. However, with respect to message 490, which corresponds to the shipment of the purchased product from the supplier 140 to the customer 110, there is no direct or prior relationship between the supplier and the customer based on the e-commerce transaction, and so the customer 110 will not be aware of that the package is originating with the supplier instead of the outlet 120. From the point of view of the customer 110, the package will appear to have been shipped by the outlet 120 because the packaging, the invoice, the shipping label, and the box all reflect the branding requirements of the outlet 120, in accordance with one aspect of the invention.

Thus, the outlet 120 has completed an e-commerce transaction with a customer 110 for a selected product that was not held in inventory by the outlet 120, by communicating with a provider 130 that aggregates suppliers 140 and the products offered by those suppliers 140, and contracting with the provider to have the selected product shipped directly to the customer 110 as though it were shipped directly from the outlet 120.

While the invention has been described in connection with a certain embodiment thereof, the invention is not limited to the described embodiments but rather is more broadly defined by the recitations in the claims below and equivalents thereof.

I claim:

1. A method in support of an e-commerce transaction between a particular outlet and a particular customer being conducted through a distributed network with respect to products not held in inventory by the particular outlet, comprising the steps of:
(a) making available for selection through the computer network a set of products for inclusion as a product offering on the particular outlet's Web site, each product being made available to the outlet at a price specified by the provider;
(b) receiving at a server of a provider a first purchase order from the particular outlet concerning a product that has been selected from the set of products, which product is offered to customers in an inventory-less manner by the particular outlet, the first purchase order including prescribed transaction details of a particular customer's e-commerce transaction with the Web site of the particular outlet;
(c) transmitting from the provider to at least one supplier a second purchase order for the selected product;
(d) awaiting an acceptance communicated from the at least one supplier that the second purchase order has been accepted; and
(e) accepting the first purchase order in response to receipt of the acceptance.

2. The method as in claim 1, wherein the prescribed transaction details include a shipping address of the particular customer, the method including the additional steps of
communicating to the accepting supplier the prescribed transaction details concerning the e-commerce transaction with the particular customer,
advising the supplier with branding requirements of the particular outlet in connection with fulfillment of the first purchase order; and
fulfilling the e-commerce transaction between the particular outlet and the particular customer by shipping the product from the accepting supplier directly to the particular customer in accordance with the branding requirements.

3. The method as in claim 1, including the additional steps of:
determining an inventory count for one or more products that have been selected by the outlet for inclusion on the particular outlet's Web site; and
pushing information concerning the determined inventory count to a server of the particular outlet.

4. The method as in claim 3, wherein the information concerning the determined inventory count comprises an out-of-stock indication.

5. The method as in claim 3, wherein the pushing step includes establishing a permission with the particular outlet to update information displayable to the particular customer through the particular outlet's Web server.

6. The method as in claim 3, wherein the inventory count determination includes a in-stock/out-of-stock of the product from more than one supplier, wherein each supplier included in the product count satisfies a rule requirement.

7. The method as in claim 1, including the additional step of providing to the accepting supplier data, which is printable so as to include the particular outlet branding requirements.

8. The method as in claim 1, wherein the step of transmitting the second purchase order is performed in accordance determinations made in relation to a rule base and data associated with each of the suppliers.

9. The method as in claim 8, wherein the determinations made in relation to the rule base comprise analysis of criteria for selecting a supplier to whom the second purchase order is to be transmitted.

10. The method as in claim 9, wherein the analysis is made of criteria which includes an inventory of the product, a price constraint, a profit margin constraint, a geographic constraint, a contractual constraint, and a combination thereof.

11. The method as in claim 1, wherein the awaiting step comprises monitoring transmissions on the computer network for the acceptance.

12. The method as in claim 1, including the additional step of securing a price commitment from the at least one supplier for at least one of the products in the set of products.

13. The method as in claim 12, including the additional step of establishing the provider price for the product after the price securing step.

14. The method as in claim 13, including the additional steps of populating a database with information concerning each products and established provider price for the product and exposing that information to the particular outlet through the computer network.

15. The method as in claim 1, including the additional step of paying the accepting supplier for the product after receiving the acceptance of the second purchase order.

16. The method as in claim 1, including the additional steps of receiving from the accepting supplier a shipping tracking number concerning the shipment of the product to the particular customer, and transmitting the shipping tracking number to the particular outlet.

17. The method as in claim 16, including the additional step of paying the accepting supplier for the product after receiving the shipping tracking number.

18. The method as in claim 1, wherein the transmitting step is from the server of the provider.
